(19) United States
(12) Patent Application Publication
(10) Pub. No.: US 2026/0128019 A1
(43) Pub. Date: May 7, 2026

(54) SOUND DAMPENING DRUMHEAD

(71) Applicant: Parish Drum Designs, LLC, Midlothian, TX (US)

(72) Inventor: John Owen Parish, Midlothian, TX (US)

(73) Assignee: Parish Drum Designs, LLC, Midlothian, TX (US)

(21) Appl. No.: 19/376,095

(22) Filed: Oct. 31, 2025

Related U.S. Application Data
(60) Provisional application No. 63/716,991, filed on Nov. 6, 2024.

(51) Int. Cl. G10D 13/20; G10K 11/00

(52) U.S. Cl. CPC G10D 13/20; G10K 11/002

(57) ABSTRACT

A sound dampening drumhead made from canvas material. The canvas material is circumferentially stretched and connected to a circular flesh hoop. The sound dampening drumhead is operable to retrofit existing drum shells and reduce drumhead reverberation time and peak volume. Further, the drumhead maintains similar reactivity as traditional drumheads.

### CROSS REFERENCES TO RELATED APPLICATIONS

This application claims the benefit of and priority to U.S. Provisional Patent Application No. 63/716,991, filed Nov. 6, 2024, which is incorporated herein by reference in its entirety.

### BACKGROUND OF THE INVENTION

### 1. Field of the Invention

The present invention relates to drumheads, more specifically sound dampening drumheads.

### 2. Description of the Prior Art

It is generally known in the prior art to use plastic mounted to metal hoops to create a drumhead.

Prior art patent documents include the following:

U.S. Patent Pub. No. 2018/0137843 for reduced volume drums and components thereof, by inventor John V. Roderick, filed Sep. 21, 2017, and published May 17, 2018, is directed to a reduced volume snare drum having a top face and a bottom face; and a snare assembly is releasably secured to the bottom face. The reduced volume snare drum includes a drum shell, a top drumhead hoop for mounting the top drumhead to the drum shell, and at least one snare mount for mounting the snare assembly to one of the drum shell or the top drumhead hoop and in contact with the bottom face. In one embodiment, the top drumhead is fabricated with a three-dimensional knitted fabric having two separate knitted substrates which are joined together by a filament or fiber.

U.S. Pat. No. 1,018,767 for a drum by inventor George Logan, filed Nov. 14, 1910, and issued Feb. 27, 1912, is directed to drums and is to provide a drum with an adjustable snare. Another object is to provide a drum having a novel means for attaching a snare thereto. Another object is to provide a drum having a fabric drum head and the means for putting the head together in order to secure the best results therefrom.

U.S. Patent Pub. No. 2013/0312585 for drum skin for volume-reduced or electronic drums by inventors Yunbin et al., filed May 24, 2012, and published Nov. 28, 2013, is directed to a drumhead for volume-reduced and electronic drums, comprising an elastic mesh, fixed on a drumframe and elastic colloidal coatings integrally formed on the upper and lower surfaces of the elastic mesh. The colloidal coating covers at least a part of the surfaces of the elastic mesh. The elastic mesh uses one of polyester mesh, nylon mesh, cotton-fiber and mesh. Said elastic colloidal coating is round and located at the center of the drum, and has an area of 5%-100% of the entire drumhead surface. By injecting the colloid on the mesh according to the invention, the strength, elasticity and wear resistance of the elastic mesh body can be improved, and the lifetime of the drumhead can be extended up to five times. This reduces the sound of the drumstick by 20 dB.

U.S. Pat. No. 7,514,617 for a practice drumhead assembly by inventors Rodgers et al., filed Jan. 19, 2006, and issued Apr. 7, 2009, is directed to a practice drumhead assembly including a mesh membrane held in substantially fixed relation to an acoustic membrane. The assembly preferably includes an annular tensioning ring for tensioning the mesh membrane, and an engagement member for substantially fixing the mesh membrane relative to the acoustic membrane. The tensioning ring includes a cylindrical rod with a turnbuckle that is rotated to increase the diameter of the tensioning ring.

U.S. Pat. No. 10,102,833 for a musical drumhead by inventor James May, filed Aug. 17, 2017, and issued Oct. 16, 2018, is directed to a musical drumhead having a plurality of multifilament yarns joined to form an open weave mesh fabric wherein the surface of the multifilament yarns is uneven or undulating for enabling a strong bond with an applied coating, which, in turn, is provided to encapsulate the individual multifilament yarns. When struck by a hard object, the open weave mesh fabric absorbs vibrations resulting in a sound that simulates the sound properties of a modern-day synthetic drumhead at substantially reduced sound levels. Integrating a plurality of soft fiber tufts into the surface (top and bottom) of the mesh fabric reduces the sound levels produced by the drumhead of the present invention even further.

The article “The Influence of Yarn and Weave Structures on Acoustic Materials and the Effect of Different Acoustic Signal Incidence Angles on Woven Fabric Absorption Possibilities,” by Bethalihem Teferi Samuel, et al. published online May 25, 2021, describes various yarn characteristics and the internal structures of weave interlacement to improve acoustic possibilities, and is incorporated herein by reference in its entirety.

### SUMMARY OF THE INVENTION

The present invention relates to sound dampening drumheads.

It is an object of this invention to reduce drumhead volume when struck with a drumstick while maintaining traditional drumhead feel and reactivity.

In one embodiment, the present invention is directed to sound dampening drumhead, including a canvas material, and a flesh hoop, wherein the canvas material is circularly stretched, wherein a circumference of the canvas material and a circumference of the flesh hoop are the same, and wherein the flesh hoop is connected to a bottom surface of the canvas material.

In another embodiment, the present invention is directed to a sound dampening drumhead, including a canvas material, and a flesh hoop, wherein the canvas material is circularly stretched, wherein a circumference of the canvas material and a circumference of the flesh hoop are greater than a circumference of a drum shell, and wherein the flesh hoop is connected to a bottom surface of the canvas material via an adhesive and/or stitching.

In yet another embodiment, the present invention is directed to a sound dampening drumhead, including a non-plastic canvas material, and a sound dampening flesh hoop, wherein the non-plastic canvas material is circularly stretched, wherein a circumference of the non-plastic canvas material and a circumference of the sound dampening flesh hoop are substantially the same, and wherein the sound dampening flesh hoop is connected to a bottom surface of the non-plastic canvas material.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1A illustrates a perspective view of a prior art drumhead.

FIG. 1B illustrates a top orthogonal view of a prior art drumhead.

FIG. 2A illustrates a perspective view of a drumhead according to one embodiment of the present invention.

FIG. 2B illustrates a top orthogonal view of a drumhead according to one embodiment of the present invention.

FIG. 2C illustrates a bottom orthogonal view of a drumhead according to one embodiment of the present invention.

FIG. 3 illustrates an enlarged view of a striking surface according to one embodiment of the present invention.

FIG. 4 illustrates a volume amplitude over time graph of a prior art drumhead.

FIG. 5 illustrates a volume amplitude over time graph of a drumhead according to one embodiment of the present invention.

### DETAILED DESCRIPTION

The present invention is generally directed to sound dampening drumheads.

In one embodiment, the present invention is directed to sound dampening drumhead, including a canvas material, and a flesh hoop, wherein the canvas material is circularly stretched, wherein a circumference of the canvas material and a circumference of the flesh hoop are the same, and wherein the flesh hoop is connected to a bottom surface of the canvas material.

In another embodiment, the present invention is directed to a sound dampening drumhead, including a canvas material, and a flesh hoop, wherein the canvas material is circularly stretched, wherein a circumference of the canvas material and a circumference of the flesh hoop are greater than a circumference of a drum shell, and wherein the flesh hoop is connected to a bottom surface of the canvas material via an adhesive and/or stitching.

In yet another embodiment, the present invention is directed to a sound dampening drumhead, including a non-plastic canvas material, and a sound dampening flesh hoop, wherein the non-plastic canvas material is circularly stretched, wherein a circumference of the non-plastic canvas material and a circumference of the sound dampening flesh hoop are substantially the same, and wherein the sound dampening flesh hoop is connected to a bottom surface of the non-plastic canvas material.

None of the prior art discloses a sound dampening drumhead including circularly stretched canvas material along a flesh hoop.

The average acoustic drum kit volume ranges from 90 to 130 decibels (dB). For reference, the decibel range for a standard acoustic drum kit is between a motorcycle revving its engine to standing near a small jet engine. Small music venues struggle to accommodate standard drum kits because the volume can overtake the other instruments and/or ruin the listening experience due to excessive decibel levels. Therefore, there is a need for a drumhead that provides a sound with a reduced volume compared to existing drumheads when struck with a drumstick.

Standard acoustic drums use KEVLAR, MYLAR, or some other synthetic polyester film for the striking surface of a drumhead. Both KEVLAR and MYLAR are plastic polymers that retain stiffness and elasticity after being struck by a drumstick. However, both KEVLAR and MYLAR are thin. Thus, when a drumstick strikes a KEVLAR, MYLAR, or any other synthetic polyester surface, the surface distorts to create a change in air pressure within a drum shell to produce a sound with a relatively loud volume. The more surface distortion, the greater the air pressure change, and the greater the air pressure change, the louder the sound. Thin polymers also continue to vibrate after being struck by a drumstick, creating drawn-out, undesirable notes. A drummer can reduce the volume by striking the striking surface more slowly. However, music requires rhythm and precision. A drummer that slows down the pace of their strikes will slow down the tempo of the music, thus changing the song. Further, if the striking surface does not create a similar drumstick recoil to KEVLAR or MYLAR, the drummer will struggle to maintain the beat of the song, or the drummer will need to produce more energy with each strike to produce the same recoil. Therefore, there is a need for a drumhead that reduces volume without compromising reactivity with a drumstick.

Traditional drumhead alternatives fail to reduce volume while maintaining striking surface reactivity. Prior art drumheads are limited to loud acoustic drumheads, electric drums, or mesh drumheads. Each prior art drumhead has severe drawbacks. As previously stated, acoustic drums include KEVLAR or MYLAR striking surfaces, producing extreme volumes. Alternatively, the surfaces of electronic drums create almost no sound when struck (just the sound of a drumstick hitting a rubber pad). An electronic drum does not produce a musical tone because nothing is vibrating over a drum shell to create sound. Electronic drums record a drumstick strike and simulate a corresponding sound via a computer system. Problematically, electronic drums are inoperable to use in small venues because striking the surface does not produce a musical tone. Similarly, mesh drumheads reduce sound so drastically that the sound is closer to typical conversational volume. A live musical performance requires more volume from all instruments, including drums, than mere conversational volume. Therefore, no prior art drumhead is operable to produce volumes sufficient to play during a concert without overpowering other instruments. There exists an unmet need for an acoustic drum that produces reduced sound compared to traditional acoustic drums.

Drummers have used KEVLAR and MYLAR drums for decades. Because KEVLAR and MYLAR have become industry standards, drum shells are designed to receive KEVLAR or MYLAR drumheads. Traditionally, the KEVLAR or MYLAR is mounted to a metal flesh hoop (i.e., metal ring), with the metal ring being mounted on a drum shell. Standard metal flesh hoops vibrate with the drumhead, increasing volume. Therefore, there is a need for a sound dampening drumhead operable to retrofit existing drum shells.

The present invention includes an acoustic drumhead material including a canvas material and a circumferential flesh hoop which provides for reduced volume when struck compared to prior art acoustic drums.

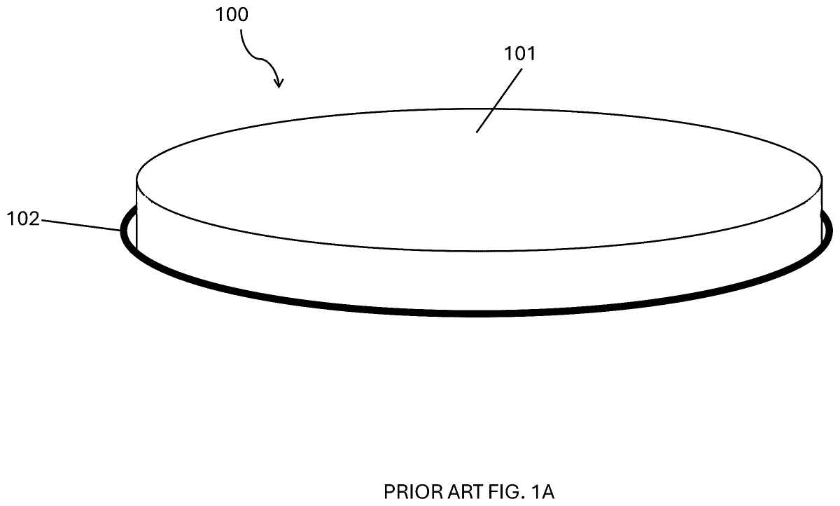

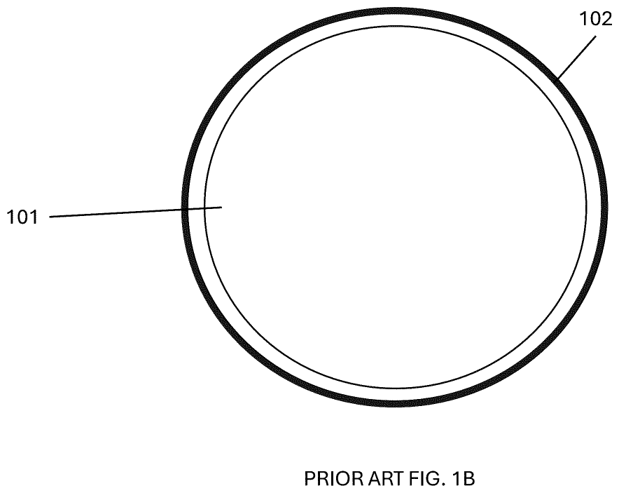

FIG. 1A illustrates a perspective view of a prior art drumhead 100 with a striking surface 101 and a metal flesh hoop 102. The striking surface 101 is typically comprised of KEVLAR or MYLAR, a thin polymer mounted circumferentially to the metal hoop 102. The striking surface 101 is inserted into a channel defined along the metal hoop 102. Because KEVLAR or MYLAR is rigid when stretched, the striking surface sits above the metal hoop 102, creating a cylinder shape, as shown in FIG. 1A.

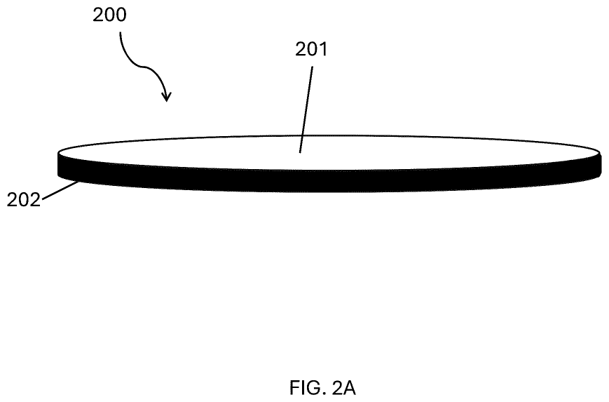

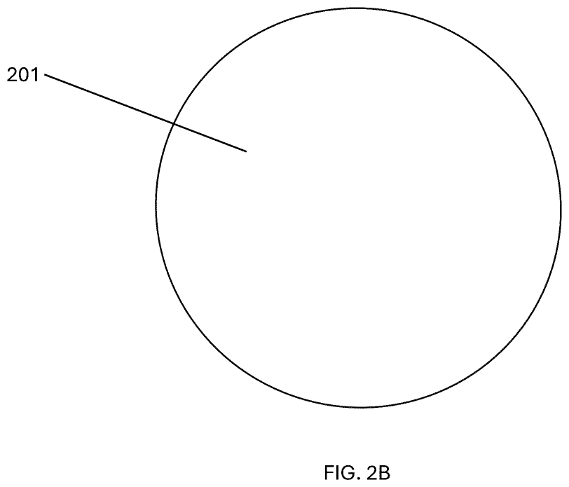

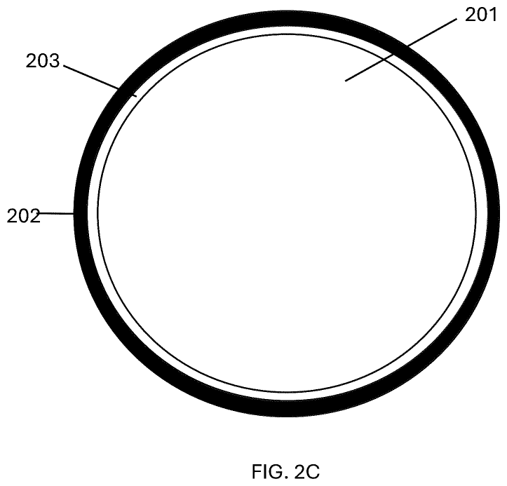

FIG. 1B illustrates a top orthogonal view of a prior art drum with striking surface 101 and metal flesh hoop 102. The metal flesh hoop 102 is circumferentially larger than the striking surface 101. The metal hoop 102 sits along a circumference of a drum shell (not depicted in FIG. 2B). Therefore, when the drumhead is connected to the drum shell, the entire striking surface 101 is above the hollow portion of the drum shell. When a drummer strikes the striking surface 101, the entire striking surface vibrates above the drum shell, creating high volume sounds. The vibrations are unimpeded and reverberate loudly. The metal hoop 102 vibrates with the striking surface 101 and propagates the vibrations to the drum shell when the striking surface 101 is struck by a drumstick, further increasing the volume of the drumhead. Prior art drums are directed to maximizing the volume of the drum, specifically teaching away from a sound dampening drumhead.

FIG. 2A illustrates a perspective view of a sound dampening drumhead 200 including a striking surface 201 and a flesh hoop 202 according to one embodiment of the present invention. The striking surface 201 is connected to the flesh hoop 202. In one embodiment, the striking surface 201 is connected to the flesh hoop 202 via an adhesive, stitching, and/or mounted to a channel in the flesh hoop 202. The flesh hoop 202 is able to be connected to the striking surface 201 in more than one configuration. In one embodiment, the flesh hoop 202 is connected to a bottom surface of the striking surface 201. In another embodiment, the flesh hoop 202 is connected to a circumference of the striking surface 201. In yet another embodiment, the flesh hoop 202 is connected to a top surface of the striking surface 201. The striking surface 201 and flesh hoop 202 are able to be the same or different sizes. In one embodiment, an edge of the striking surface 201 aligns with an edge of the flesh hoop 202 such that the striking surface 201 and the flesh hoop 202 create a substantially flat surface, the substantially flat surface being perpendicular to the striking surface 201. In another embodiment, the striking surface 201 is circumferentially smaller than the flesh hoop 202. In another embodiment, the striking surface 201 is circumferentially larger than the flesh hoop 202. In yet another embodiment, an edge of the striking surface 201 does not align with an edge of the flesh hoop 202.

Importantly, the material comprising the striking surface 201 greatly impacts volume. In one embodiment, the striking surface 201 includes a canvas material. Notably, the canvas material provides similar reactive properties as traditional drumheads. In a preferred embodiment, striking surface 201 has no holes and does not include mesh, producing greater volumes than a mesh or electronic drumhead while still reducing drumhead volume relative to a traditional drumhead including a polymer striking surface. In one embodiment, striking surface 201 includes a canvas material including wool, woven fabric, yarn, and/or any other non-plastic material. In one embodiment, yarn further includes natural and/or synthetic fibers. Natural fibers include cotton, linen, hemp, bamboo, wool, silk, angora, cashmere, and/or mohair. Synthetic fibers include nylon, acrylic, polyester, and/or blends of any combination of synthetic and natural fibers.

In one embodiment, the striking surface 201 includes a canvas material including a woven material such as cotton duck fabric. In one embodiment, the woven material includes yarn. In one embodiment, the woven material includes single filled duck fabric, numbered duck fabric (i.e., double filled), army duck fabric, any other duck fabric, and/or any combination thereof. Each duck fabric is differentiated by yarn material, yarn and/or fabric thickness, and/or yarn/fabric weight. In one embodiment, each duck fabric is able to include any yarn thickness sufficient to reduce drumhead volume.

In one embodiment, the striking surface 201 includes a canvas material including single filled duck fabric. Single filled duck fabric is generally lightweight and loosely woven using non-plied single yarns. Single filled duck fabric includes one yarn in the weft and one yarn in the warp. Single filled duck fabric is soft, durable, and versatile.

In one embodiment, the striking surface 201 includes a canvas material including numbered duck fabric (i.e., double filled). Numbered duck fabric is heavier than single filled duck fabric because the numbered duck fabric includes more yarns and/or plied yarns. Numbered duck fabric can include any yarn thickness and range between #1 (heaviest) and #12 (lightest). In one embodiment, numbered duck fabric includes two yarns in the weft and one yarn in the warp. To increase weight, thickness, durability, and structural integrity, in one embodiment, numbered duck fabric can include two yarns in the weft and two yarns in the warp.

In another embodiment, the striking surface 201 includes canvas material including jute, denim, vinyl, nylon, leather, and/or heavy cotton. In another embodiment, the striking surface 201 includes plastic and/or polymer-type material. In another embodiment, the canvas material includes any combination of cotton, hemp, wool, woven fabric, jute, denim, leather, heavy cotton, plastic, and/or polymer blended material. In another embodiment, the striking surface 201 is not plastic.

In yet another embodiment, the striking surface 201 includes a canvas material including army duck fabric. Army duck fabric is typically a plain weave architecture using two ply yarns, creating a finer and tighter weave than single filled duck fabrics. In one embodiment, the canvas material is able to include any other duck fabric known in the art and should not be limited to the aforementioned examples.

The weave pattern of the canvas material directly correlates to volume reduction. The weave pattern refers to the number of yarns in the warp and weft. For context, weft yarn is the yarn that is woven across the width of a fabric, passing horizontally through a lengthwise warp yarn. Weave pattern further refers to plied and/or non-plied yarns, yarn thickness, and yarn weight. In a preferred embodiment, the striking surface 201 comprises canvas material. The canvas material further comprises a woven fabric material. The woven fabric material further comprises duck fabric. Single filled duck fabric has one yarn in the weft and one yarn in the warp, creating a softer fabric that is looser than numbered duck fabric, creating less recoil when struck by a drumstick. Preferably, the woven fabric canvas material is numbered duck fabric. Numbered duck fabric uses plied yarns, or yarns that are twisted together to increase strength. The plied yarns are woven together with at least one yarn in the weft and at least one yarn in the warp, creating a strong material that reacts like a traditional drumhead when struck with a drumstick. In one embodiment, numbered duck fabric uses two yarns in the weft and one yarn in the warp. Preferably, numbered duck fabric is woven tightly enough to create a water-tight fabric with no holes. Numbered duck fabric is impermeable to water and reacts similarly to a traditional drumhead, unlike mesh drumheads that comprise holes and gaps in the surface. Mesh drumheads specifically teach away from airtight material because the purpose of mesh is to allow air to pass through the surface to reduce vibrations. In one embodiment, the striking surface 201 includes plied yarns woven together with at least two yarns in the weft and at least two yarns in the warp. In another embodiment, the striking surface 201 includes non-plied yarns woven together with at least one yarn in the weft and at least one yarn in the warp. In another embodiment, the striking surface 201 includes plied and/or non-plied yarn and further includes at least one yarn in the weft and at least one yarn in the warp.

The weft and warp architecture affects sound volume. In a preferred embodiment, striking surface 201 comprises canvas material. In one embodiment, the canvas material further comprises a woven fabric material. Woven fabric canvas material is able to include 4-harness satin (crow's foot), 5-harness satin, 8-harness satin, plain, twill, and/or basket architecture. Air permeability of different weave architecture changes the woven fabric canvas material's sound absorbing properties. “The Influence of Yarn and Weave Structures on Acoustic Materials and the Effect of Different Acoustic Signal Incidence Angles on Woven Fabric Absorption Possibilities,” incorporated here by reference in its entirety, demonstrates the hierarchy of weave architecture sound absorbing properties, depending on yarn type and weave architecture. In one embodiment, the striking surface 201 includes plain weave woven fabric canvas material. In another embodiment, the striking surface 201 includes 4-harness satin, 5-harness satin, 8-harness satin, twill and/or basket weave woven fabric canvas material. Importantly, the tighter the weave architecture, the more the striking surface vibrates when struck, producing louder volumes. The object of the embodiments described herein is to dampen drumhead volume without completely muting the volume. Therefore, in a preferred embodiment, the weave architecture is tightly woven to create recoil properties similar to a traditional drumhead and produce sufficient drumhead volume that is still significantly lower than traditional drumheads. In a preferred embodiment, the woven fabric consists of closed woven weft and warp architectures. The weft and the warp yarn and/or yarns are woven together tightly enough to create a closed-weave fabric. For avoidance of doubt, the weft and the warp yarn are woven together such that the fabric is not open weave.

The striking surface thickness affects volume. Increasing the thickness of the striking surface reduces vibrations, thus reducing volume. Traditionally, increasing the thickness of the striking surface required adhering multiple layers to the striking surface. However, creating a layered striking surface changes the vibration pattern because each layer will not vibrate simultaneously and will vibrate at slightly different frequencies, changing the intended tone of the drumhead. The top layer will begin to vibrate first, then each subsequent layer will vibrate slightly less. MYLAR and KEVLAR drumheads can include layers, such as double ply, which produce deeper tones than a single layer drumhead, whereas single ply produces louder, higher-pitched tones. Therefore, it is advantageous for the striking surface to include only a single layer to create uniform tones and consistent vibration patterns while still reducing volume. In one embodiment, the striking surface consists of a canvas material consisting of a single layer of woven fabric.

In one embodiment, a striking surface includes a woven material, with the woven material further including yarn. Since yarn thickness affects the overall layer thickness of the striking surface, thicker yarn creates greater sound dampening properties. In a preferred embodiment, the striking surface 201 includes a canvas material that is able to be different thicknesses, depending on the weave pattern and yarn used. In one embodiment, the canvas material is numbered duck fabric including any numbered duck fabric from #12 to #1, with #12 duck fabric being the finest, thinnest material, which produces the most vibrations, and #1 duck fabric being the coarsest, thickest texture, which produces the least vibrations. In one embodiment, the canvas material is #1 numbered duck fabric. In another embodiment, the canvas material is #12 numbered duck fabric. In yet another embodiment, the canvas material is any numbered duck fabric #12 through #1. In a preferred embodiment, the canvas material is #6 duck fabric. In a preferred embodiment, the #6 duck fabric consists of double fill weave architecture, yarn woven, and is single layered. It should be noted that the striking surface is able to include any yarn thickness, which affects overall striking surface thickness. In one embodiment, the striking surface includes plied yarn. In another embodiment, the striking surface includes non-plied yarn.

Further, striking surface thickness impacts the resonance and/or the length of the note. The thicker the striking surface, the shorter the amount of time the striking surface vibrates, decreasing the length of the note. Conversely, the thinner the striking surface, the longer the amount of time the striking surface vibrates, increasing the length of the note. As striking surface thickness increases, the greater the dissipation of kinetic energy throughout the striking surface, causing the striking surface to resonate for a shorter amount of time. In one embodiment, the striking surface is thicker than a traditional drumhead.

The striking surface weight affects sound volume. Increasing the weight of the striking surface reduces vibrations, thus reducing volume. In one embodiment, the striking surface includes canvas material. In one embodiment, the canvas material includes woven fabric. The woven fabric varies in weight depending on the weave architecture and material used. In one embodiment, the material used for the woven fabric includes yarn. In one embodiment, the woven fabric includes single filled duck fabric that uses non-plied single yarns, creating a canvas material weighing between about 7 and about 12 ounces per square yard. In another embodiment, the woven fabric includes numbered duck fabric that uses plied and single and/or double filled yarn, creating a canvas material weighing between about 12 ounces and about 32 ounces per square yard. In yet another embodiment, the woven fabric includes army duck fabric, creating a canvas material weighing between about 10 and about 15 ounces per square yard. In one embodiment, the striking surface can weigh between about 7 ounces and about 32 ounces per square yard. In a preferred embodiment, the striking surface weighs about 13 ounces per square yard.

Coating the striking surface affects the volume. In one embodiment, striking surface 201 is coated with a coating composition. In one embodiment, the coating composition includes oil, wax, spray rubber, and/or any other coating composition capable of creating an airtight seal. In one embodiment, the striking surface 201 is completely coated. In another embodiment, the striking surface 201 is partially coated. In yet another embodiment, the striking surface 201 is coated circumferentially such that a ring of coating is applied to the striking surface 201. In yet another embodiment, the striking surface 201 is not coated.

FIG. 2B illustrates a top orthogonal view of a sound dampening drumhead with a striking surface 201 according to one embodiment of the present invention. In this embodiment, the striking surface 201 is the entire top surface of the sound dampening drumhead. In this embodiment, a flesh hoop is connected to a bottom surface of the striking surface 201 such that when the striking surface 201 vibrates, the flesh hoop absorbs some of the striking surface's 201 kinetic energy and dampens the volume. In a preferred embodiment, the flesh hoop includes a sound dampening material. Alternatively, in one embodiment, the flesh hoop includes metal.

FIG. 2C illustrates a bottom orthogonal view of a sound dampening drumhead including a striking surface 201, a flesh hoop 202, and a circumferential coated portion 203 according to one embodiment of the present invention. The flesh hoop 202 connects to a bottom surface of the striking surface 201. In one embodiment, the flesh hoop 202 includes an outer circumference equal to the circumference of the striking surface 201. In another embodiment, the flesh hoop 202 includes an outer circumference less than the circumference of the striking surface 201. In yet another embodiment, the flesh hoop includes an outer circumference greater than the circumference of the striking surface 201. In a preferred embodiment, the flesh hoop 202 includes a sound dampening material. In one embodiment, the flesh hoop includes leather or consists of leather. In another embodiment, the flesh hoop includes any material operable to absorb kinetic energy from the striking surface to dampen the volume. In another embodiment, the flesh hoop 202 is not metal. In yet another embodiment, the flesh hoop 202 is metal.

The ability to retrofit existing drumheads is critical. The flesh hoop 202 corresponds to a traditional flesh hoop such that a drum shell that traditionally receives a metal flesh hoop similarly receives the flesh hoop 202 of the present invention. Although not depicted in FIG. 2, the sound dampening drumhead of the present invention is operable to connect to a drum shell via any method known in the art. Traditionally, the flesh hoop 202 includes a circumference slightly smaller than a circumference of a drum shell. The difference between the circumferences of the flesh hoop and the drum shell ensures ample room to tension a canvas material drumhead according to one embodiment of the present invention.

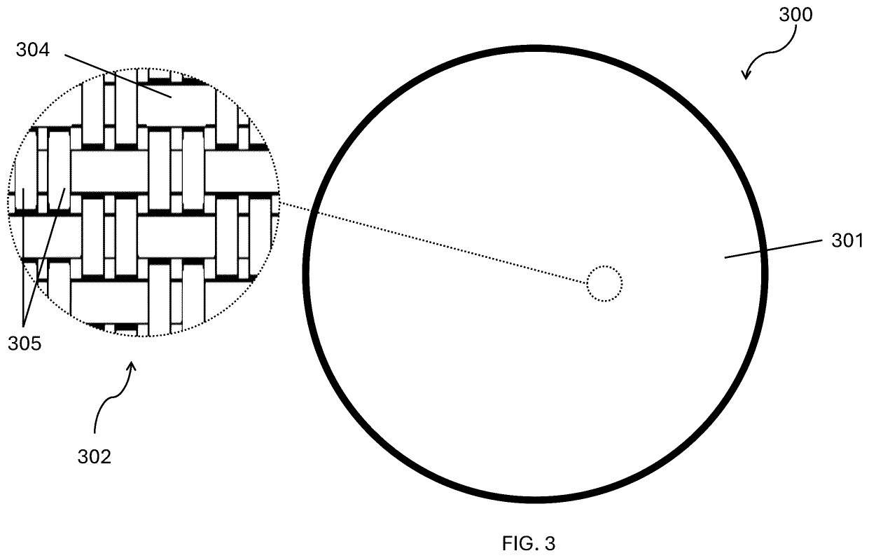

FIG. 3 illustrates a drumhead 300 including striking surface 301 and an enlarged view 302 of the striking surface 301 according to a preferred embodiment of the present invention. In one embodiment, the striking surface 301 includes a canvas material. The canvas material includes woven fabric. In one embodiment, the woven fabric further includes duck woven fabric with at least two yarns 305 in the warp direction and at least one yarn 304 in the weft direction. In this embodiment, two different yarn sizes are used. The at least two yarns 305 in the warp are smaller than the at least one yarn in the weft. Notably, the canvas material is stretched to the outer circumference of the drumhead 300. Importantly, the drumhead 300 retains recoil properties similar to a traditional drumhead. FIG. 3 is not to scale and only intended to represent a preferred weave pattern and architecture according to one embodiment of the present invention. Further, FIG. 3 illustrates a canvas material before the yarn is tightly woven. Thus, the gaps between the yarn illustrated in FIG. 3 are not present in a preferred embodiment of the present invention because FIG. 3 is merely meant to illustrate a weave pattern. In another embodiment, the drumhead 300 includes at least one yarn in the warp and at least one yarn in the weft. In another embodiment, the drumhead 300 includes at least two yarns in the warp and at least two yarns in the weft. In another embodiment, the drumhead 300 includes any combination of yarns in the warp and weft sufficient to produce drumhead reactivity similar to traditional drumheads.

### Sound Equalization

A sound dampening drumhead including a canvas material naturally equalizes the sound of a drumhead after the drumhead is struck. Traditionally, acoustic drumheads, including KEVLAR or MYLAR, require additional equipment to equalize the sound. Equalizing drumhead sound requires adjusting the volume of different frequency bands within an audio signal. A traditional acoustic drum continues to vibrate long after a drummer strikes the striking surface, creating continual tone generation for as long as the drumhead vibrates. Therefore, during a musical performance that requires continuous striking of a traditional drumhead, the drumhead will vibrate the entire song due to the drawn-out vibration pattern. The continuous vibration creates unnecessary noise, pollutes other instruments, and often requires external equalizing equipment to produce a more desirable sound.

### Drumhead Comparison

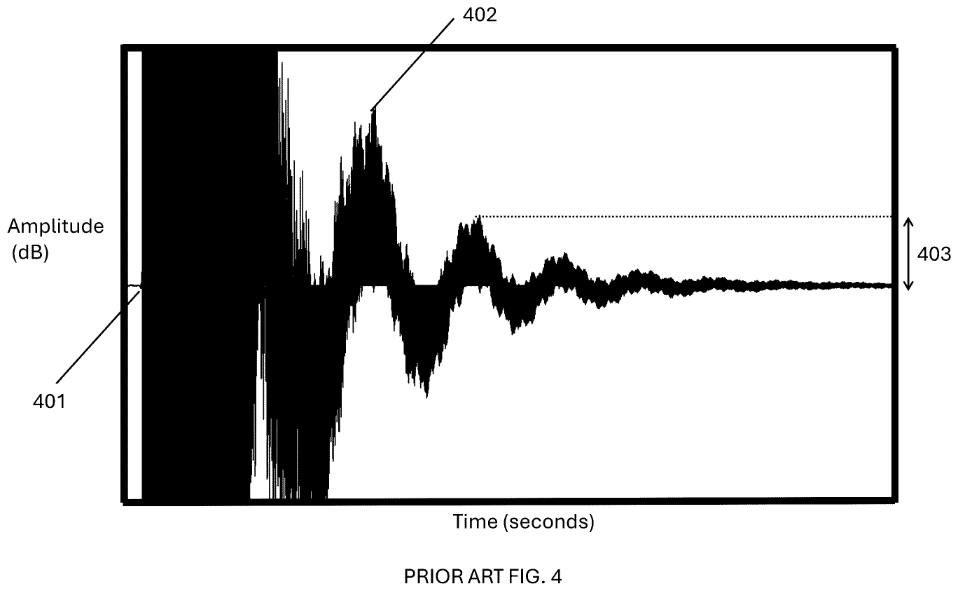

FIG. 4 illustrates a volume amplitude over time graph of a LUDWIG CLASSIC MAPLE prior art drum including a strike moment 401, a second peak 402, and a loudness level 403. The Tom 1 drumhead strike used to generate FIG. 4 is a synthetic polyester film drumhead. The strike moment 401 is the instant a drummer strikes a traditional acoustic drumhead. Positive and negative peaks of the graph illustrated in FIG. 4 represent moments of air compression within the drum, where the further the peak is from the center, the louder a volume is produced. A first peak, representing maximum volume, is not depicted because the amplitude of the sound wave created from the strike is greater than the upper and lower limits of the chart. However, a representative second peak 402 illustrates reverberating loudness after the strike moment 401. Noticeably, the graph closely represents a decaying sinusoidal wave, where each peak produces a corresponding volume 403 while the drumhead vibrates. Importantly, the standard drumhead strike depicted in FIG. 4 resonates for approximately 5.359 seconds. To produce a smooth sound in a small venue, equalizing equipment is required to reduce the total number of peaks produced when a drummer strikes a traditional drumhead and to neutralize the negative peaks opposite peak 402.

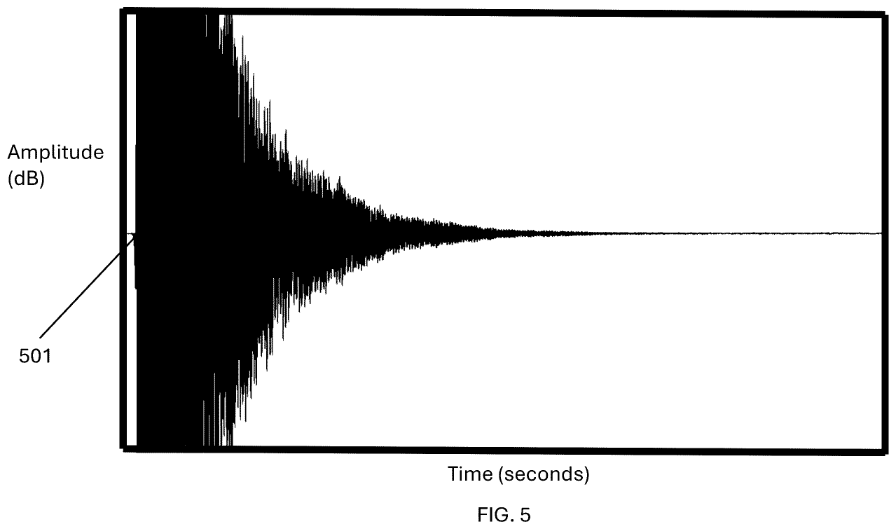

Comparatively, FIG. 5 illustrates a volume amplitude over time graph of a drumhead including a strike moment 501 according to one embodiment of the present invention. FIG. 5 represents data gathered on a strike on a Tom 1 drumhead including a double filled #6 numbered duck fabric drumhead and the same drum shell as the Tom 1 drum used to create the data for FIG. 4. Importantly, the initial striking force and drumstick used to produce FIG. 5 and FIG. 4 are identical. The strike moment 501 is the instant a drummer strikes a canvas drumhead. The maximum peak, representing maximum volume, is not depicted. The vibration pattern is drastically different from the prior art sinusoidal pattern depicted in FIG. 4. Importantly, there are no constant reverberations of loudness after strike moment 501. The amplitude continues to exponentially decrease until the drumhead stops vibrating. Importantly, the drumhead, according to this embodiment, resonates for approximately 2.063 seconds. In this embodiment, the drumhead vibration time is reduced by approximately 38.5%. The drumhead according to this embodiment reduces average volume by reducing sinusoidal volume spikes and shortening the vibration time after strike moment 501. Advantageously, the drumhead according to the embodiment depicted in FIG. 5 naturally equalizes the sound and produces a truer tone without a drawn-out note lasting over 5 seconds. Natural equalization occurs because there are no continuous reverberations that require neutralization.

Drumhead volume comparisons between synthetic polyester drumheads and a canvas material including a double filled #6 numbered duck fabric drumhead according to one embodiment of the present invention are detailed herein. The testing included equal striking force using identical drumsticks to ensure accuracy. Each drum strike was recorded with a microphone. The microphone was positioned an identical distance, configuration, and location away from each drumhead surface for each test. The microphone recorded the sound produced by the drumstick striking a striking surface of the synthetic polyester drumhead and a canvas material drumhead for a predetermined, consistent time, measured in decibels. For decibel calculations using electronic recording equipment, 0 dB is the maximum volume before the sound becomes damaged. The further negative a decibel reading, the quieter the sound. Typically, a digital limit for a recorded loudness is between −96 dB (quietest) and 0 dB (loudest). Common data points for drum volume and tone length include calculating the root mean square (RMS) and peak volume (hereinafter, “peak”), each measured in decibels. The RMS is a mathematical calculation used to measure the average loudness of a sound wave over a period of time. Thus, the RMS value is an average amplitude of a sound wave over time, indicating the drumhead's ability to continue to vibrate after a drumstick strikes the drumhead. Peak is the maximum loudness, such as the instant a drumstick strikes the drumhead.

TABLE 1
RMS and Peak Measurements

| | Synthetic Polyester | | Canvas | |
|---|---|---|---|---|
| | Film Drumhead | | Drumhead | |
| Drum Type | RMS (dB) | Peak (dB) | RMS (dB) | Peak (dB) |
| Kick | −29.2 | −0.1 | −36.2 | −7.2 |
| Snare Top | −32.1 | −1.2 | −42.8 | −14.2 |
| Snare Bottom | −33.1 | 0 | −47.3 | −16.9 |
| Tom 1 | −32.9 | −1.5 | −45.2 | −14.7 |
| Tom 2 | −33.5 | −3.4 | −52.6 | −20.1 |
| Overheads | −29.3 | −0.7 | −44.4 | −13.3 |
| Rooms | −19.1 | −1.5 | −32.9 | −7.8 |
| Hi-Hat | −30.8 | 0 | −49.6 | −16.6 |

Canvas drumheads outperformed synthetic polyester film drumheads on every drum shell type. The RMS value for synthetic polyester film drumheads is consistently closer to 0 dB than canvas drumheads, indicating synthetic polyester drumheads vibrate longer after an initial drumstick strike. Therefore, the average loudness over the same period of time for synthetic polyester drumheads is higher than the canvas material drumhead. The reduced RMS for the canvas drumhead is a result of sound dampening properties in the material.

The peak for synthetic polyester film drumheads is within 3.4 dB of the loudest obtainable sound for an audio recording, as every data point is at or near the 0 dB maximum. Contrarily, canvas drumheads were at least 7.2 decibels from the 0 dB maximum, indicating the initial drumhead strike produced a lower maximum volume.

Data from Table 1 is measured in decibels (a logarithmic scale). Therefore, to clearly indicate volume differences between the synthetic polyester drumhead and the canvas material drumhead, the RMS and peak must be converted from decibels to a perceived loudness factor (PLF). The PLF is a unitless value that indicates a factor difference between the RMS and peak values for each drumhead. (i.e., the canvas drumhead has an RMS 1.4× quieter than the synthetic polyester drumhead). To calculate the RMS PLF, the difference between the synthetic polyester drumhead RMS and the canvas drumhead RMS is determined (RMS Difference). Next, the RMS Difference is divided by a constant logarithmic decibel increase of 10 dB (or a 2× volume increase, equivalent to dividing by 5). The same calculation was performed for peak PLF by calculating the difference between the synthetic polyester drumhead and the peak canvas drumhead (Peak Difference) and dividing the Peak Difference by the constant logarithmic decibel increase of 10 dB. Importantly, negative perceived loudness factors indicate a decrease in loudness, i.e., a negative perceived loudness factor indicates a quieter drumhead.

TABLE 2
Perceived Loudness Factors

| | RMS | | Peak | |
|---|---|---|---|---|
| Drum Type | Difference | RMS PLF | Difference | Peak PLF |
| Kick | −7.0 | −1.4x | −7.1 | −1.4x |
| Snare Top | −10.7 | −2.1x | −13.0 | −2.6x |
| Snare Bottom | −14.2 | −2.8x | −16.9 | −3.4x |
| Tom 1 | −12.3 | −2.5x | −13.2 | −2.6x |
| Tom 2 | −19.1 | −3.8x | −16.7 | −3.3x |
| Overheads | −15.1 | −3.0x | −12.6 | −2.5x |
| Rooms | −13.8 | −2.8x | −6.3 | −1.3x |
| Hi-Hat | −18.8 | −3.8x | −16.6 | −3.3x |

Every drum type using a canvas material drumhead produced a lower volume than the corresponding synthetic polyester drumhead. A canvas material drumhead, according to one embodiment of the present invention, creates volumes up to 3.8× quieter than traditional drumheads while still producing the same feel and reactivity. Importantly, the data presented in Table 1 and Table 2 reflect volume differences according to a single embodiment of the present invention. It should be noted that the canvas material should not be limited by this embodiment. Rather, the data presented in Table 1 and Table 2 are merely a representative sample of how effective a canvas material drumhead is at reducing drumhead volume.

The above-mentioned examples are provided to serve the purpose of clarifying the aspects of the invention, and it will be apparent to one skilled in the art that they do not serve to limit the scope of the invention. By nature, this invention is highly adjustable, customizable and adaptable. The above-mentioned examples are just some of the many configurations that the mentioned components can take on. All modifications and improvements have been deleted herein for the sake of conciseness and readability but are properly within the scope of the present invention.

The invention claimed is:

1. A sound dampening drumhead, comprising:
a canvas material; and
a flesh hoop;
wherein the canvas material is circularly stretched;
wherein a circumference of the canvas material and a circumference of the flesh hoop are the same; and
wherein the flesh hoop is connected to a bottom surface of the canvas material.

2. The sound dampening drumhead of claim 1, wherein the canvas material includes a woven fabric.

3. The sound dampening drumhead of claim 2, wherein the woven fabric includes duck woven fabric.

4. The sound dampening drumhead of claim 2, wherein the woven fabric includes yarn of a first type and yarn of a second type.

5. The sound dampening drumhead of claim 4, wherein the yarn of the first type is of a different size than the yarn of the second type.

6. The sound dampening drumhead of claim 2, wherein the woven fabric includes at least two yarns in the warp and at least one yarn in the weft.

7. The sound dampening drumhead of claim 1, wherein the canvas material does not include any gaps.

8. The sound dampening drumhead of claim 1, wherein the flesh hoop is not metal.

9. A sound dampening drumhead, comprising:
a canvas material; and
a flesh hoop;
wherein the canvas material is circularly stretched;
wherein a circumference of the canvas material and a circumference of the flesh hoop are greater than a circumference of a drum shell; and
wherein the flesh hoop is connected to a bottom surface of the canvas material via an adhesive and/or stitching.

10. The sound dampening drumhead of claim 9, wherein the canvas material includes a woven fabric.

11. The sound dampening drumhead of claim 10, wherein the woven fabric includes duck woven fabric.

12. The sound dampening drumhead of claim 10, wherein the woven fabric includes yarn of a first type and a second type.

13. The sound dampening drumhead of claim 12, wherein the yarn of the first type is of a different size than the yarn of the second type.

14. The sound dampening drumhead of claim 10, wherein the woven fabric includes at least two yarns in the warp and at least one yarn in the weft.

15. The sound dampening drumhead of claim 9, wherein the canvas material does not include any gaps.

16. The sound dampening drumhead of claim 9, wherein the flesh hoop is metal.

17. A sound dampening drumhead, comprising:
a non-plastic canvas material; and
a sound dampening flesh hoop;
wherein the non-plastic canvas material is circularly stretched;
wherein a circumference of the non-plastic canvas material and a circumference of the sound dampening flesh hoop are substantially the same; and
wherein the sound dampening flesh hoop is connected to a bottom surface of the non-plastic canvas material.

18. The sound dampening drumhead of claim 17, wherein the non-plastic canvas material includes a woven fabric.

19. The sound dampening drumhead of claim 17, wherein the non-plastic canvas material includes plied yarn.

20. The sound dampening drumhead of claim 17, wherein the non-plastic canvas material is waterproof.
